(19) United States
(12) Patent Application Publication
(10) Pub. No.: US 2008/0220809 A1
(43) Pub. Date: Sep. 11, 2008

(54) METHOD AND SYSTEM FOR A SELF TIMER FUNCTION FOR A CAMERA AND ...

(75) Inventor: Anders Hansen, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/683,038

(22) Filed: Mar. 7, 2007

(51) Int. Cl. H04M 1/00; H04N 5/222

(52) U.S. Cl. 455/550.1; 348/333.01; 348/E05.022

(57) ABSTRACT

An electronic equipment includes a camera for taking digital photographs. The electronic equipment further includes a radio circuit for establishing communication with a communications network, a camera for taking digital photographs; a display, and a control circuit. The control circuit is configured to execute image detection logic to: periodically acquire an image and storing a least one of the acquired images in the memory; processing the periodically acquired images to determine an occurrence of a predefined event; and performing a function based upon the occurrence of the predefined event.

### TECHNICAL FIELD OF THE INVENTION

The present invention relates generally to electronic equipment, such as electronic equipment for taking pictures and/or for engaging in voice communications. More particularly, the invention relates to a method and system for a camera and/or camera equipped mobile radio terminal to detect a predetermined user action and perform a subsequent function.

### DESCRIPTION OF THE RELATED ART

Mobile and/or wireless electronic devices are becoming increasingly popular. For example, digital cameras, mobile telephones and portable media players are now in wide-spread use. In addition, the features associated with certain types of electronic devices have become increasingly diverse. To name a few examples, many electronic devices have cameras, text messaging capability, Internet browsing functionality, electronic mail capability, video playback capability, audio playback capability, image display capability and hands-free headset interfaces.

Many digital cameras and camera equipped mobile radio terminals include a self-timer function. The self-timer function is generally used to allow the individual taking the picture to be included in the photograph. A self-timer may be used in a variety instances, for example, when the photographer is taking photographs of groups of people, when the photographer desires to have a photograph of himself or herself at a particular location and/or scene, and even when the photographer desires to take a portrait.

In conventional use, the device taking the photograph (e.g., a digital camera, camera equipped mobile radio, etc.) is usually set on a tripod or level surface. The self-timer function is activated by the user. Once activated, a predetermined amount of time elapses and a photograph is then taken. In this conventional scenario, the photographer typically must scurry to get into the proper position prior to the photograph being taken. In this scenario, the photographer is not typically allotted sufficient time to relax in front of the camera. This problem is compounded when the photographer desires to take a photograph of a large group of people and/or scene. In such circumstances, the photographer must traverse a longer distance to be included in the photograph in typically the same amount of time. Accordingly, in many instances the photographer is not able to relax and often times appears disheveled.

Many devices that utilize a camera let the photographer let the photographer select the time it takes for the self-timer to take a photograph. Usually such time periods are between two and ten seconds. More advanced models allow the photographer to set a desired time before the photograph is taken. A problem with such approaches is that the longer the period of time that expires between the time the photographer initiates the self-timer function and the time it takes for the photograph to be taken, a variety of unwanted occurrences may occur, for example, subjects not looking at the camera, subjects closing their eyes, subjects moving, etc.

Accordingly, there is a need in the art for an improved way of providing a self-timer on a camera and/or a camera equipped mobile radio terminal.

### SUMMARY

According to one aspect of the invention, a method of using a camera, the method comprising: providing a camera including a display for presenting one or more images in a viewfinder to an associated user, a memory for storing the one or more images, and a processor for processing information associated with the image and displaying the one or more images on the display; activating the camera circuitry; setting the camera circuitry in an image detection mode; periodically acquiring images in the viewfinder and storing a least one of the acquired images in the memory; processing the periodically acquired images to determine an occurrence of a predefined event; and performing a function based upon the occurrence of the predefined event.

According to another aspect of the invention, the camera is housed in a mobile telephone.

According to another aspect of the invention, the camera is configured to be set to the image detection mode by an associated user depressing a key.

According to another aspect of the invention, the periodically acquired images are acquired in a period of less than ten seconds from each other.

According to another aspect of the invention, learning the one or more predefined events and storing the one or more predefined events in memory.

According to another aspect of the invention, the step of learning the one or more predefined events includes determining differences in the periodically acquired images.

According to another aspect of the invention, the step of processing the periodically acquired images includes searching for one or more predefined events in at least one image.

According to another aspect of the invention, the one or more predefined events includes a user gesture from an associated user located in the image view field.

According to another aspect of the invention, the function includes acquiring an image after the occurrence of the predefined event.

According to another aspect of the invention, a predefined time expires prior to performing the function after the occurrence of the predefined event.

According to another aspect of the invention, the function includes acquiring a video of the view field after the occurrence of the predefined event.

According to another aspect of the invention, the function includes acquiring a series of images in the form of individual images at a predetermined time interval after the occurrence of the predefined event.

According to another aspect of the invention, a mobile radio terminal, comprising: a radio circuit for establishing communication with a communications network; a camera for taking digital photographs; a display; and a control circuit configured to execute image detection logic to: periodically acquiring images and storing a least one of the sampled view fields in the memory; processing the periodically acquired images to determine an occurrence of a predefined event; and performing a function based upon the occurrence of the predefined event.

According to another aspect of the invention, the control circuit is configured to execute the image detection mode by an associated user depressing a key.

According to another aspect of the invention, the periodically acquired image occurs in a period of less than ten seconds.

According to another aspect of the invention, the mobile radio terminal further includes a memory for storing one or more predefined events, wherein the memory is coupled to the control circuit.

According to another aspect of the invention, the step of processing the periodically acquired image includes searching for one or more predefined events in the image stored in memory.

According to another aspect of the invention, the one or more predefined events includes a user gesture from an associated user located in the image.

According to another aspect of the invention, the function includes acquiring an image after the occurrence of the predefined event.

According to another aspect of the invention, a predefined time expires prior to performing the function after the occurrence of the predefined event.

According to another aspect of the invention, an electronic equipment, comprising: a camera for taking digital photographs; a display; and a control circuit configured to execute image detection logic to: periodically acquiring images and storing a least one of the sampled view fields in the memory; processing the periodically acquired images to determine an occurrence of a predefined event; and performing a function based upon the occurrence of the predefined event.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIGS. 1A and 1B are schematic front view and rear view, respectively, of a mobile telephone as an exemplary electronic equipment in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIG. 4 is a flow chart of an exemplary camera function in accordance with the present invention.

FIG. 5 is another exemplary representation of a mobile telephone as an exemplary electronic equipment when the mobile telephone is placed in a camera mode;

FIG. 6 is an illustration of an exemplary application in accordance with aspects of the present invention.

### DETAILED DESCRIPTION OF EMBODIMENTS

The present invention will now be described with reference to the drawings, wherein like reference numerals are used to refer to like elements throughout. It will be understood that the figures are not necessarily to scale.

The term “electronic equipment” includes portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of appropriate electronic equipment. Also, embodiments of the invention are described primarily in the context of changing digital camera modes in preparation for detecting user movements to activate a self-timer function of the digital camera. However, it will be appreciated that the invention is not intended to be limited to detecting user movement for initiation of the self-timer function only. For instance, the invention may have application to the changing of photographic modes (e.g., still photography mode, sport photography mode, video mode, etc.), changing of photographic settings, and/or activating accessories associated with the mobile telephone and/or camera based upon the detected user movement.

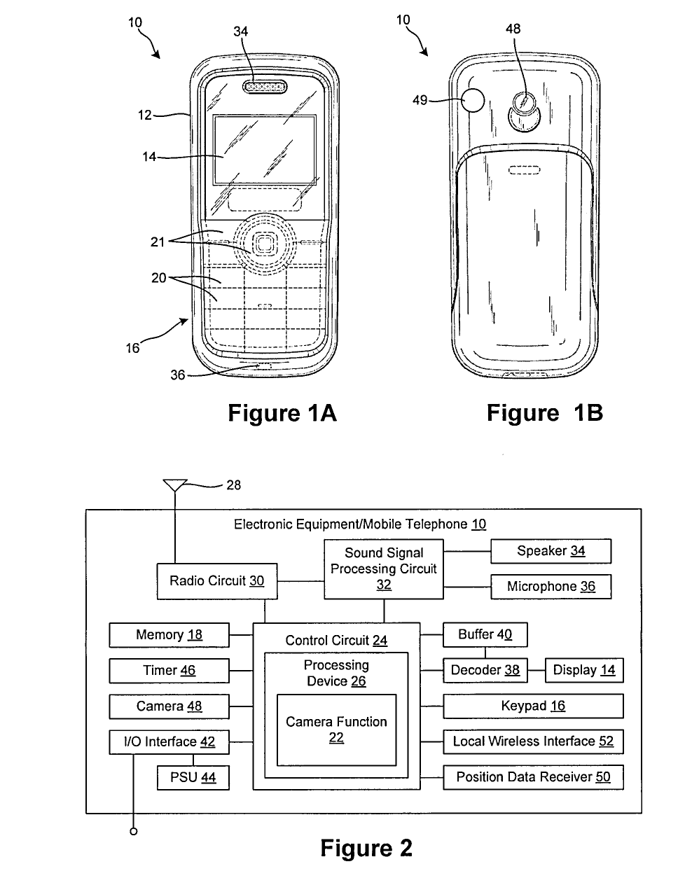

Referring initially to FIGS. 1A and 1B, an electronic equipment 10 is shown in accordance with the present invention. The electronic equipment includes a camera function that is configured to control a camera of the electronic equipment and process image data captured by the camera. It will be appreciated that the camera function may be embodied as executable code that may be resident in and executed by the electronic equipment 10.

The electronic equipment in the illustrated embodiments is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized.

The mobile telephone 10 includes a display 14 and keypad 16. The display 14 displays information to a user such as operating state, time, telephone numbers, contact information, various navigational menus, etc., which enable the user to utilize the various features of the mobile telephone 10. The display 14 may also be used to visually display content received by the mobile telephone 10 and/or retrieved from a memory 18 (FIG. 2) of the mobile telephone 10. In addition, an image may be displayed on the display 14, such as a photograph taken by a camera of the mobile telephone 10 or a photo preview image when the display 14 functions as an electronic viewfinder for the camera. As will be described in greater detail below, a camera setting menu, or “optimization menu,” may be displayed on the display 14 to graphically assist the user change camera setting before taking a photograph.

The keypad 16 may provide for a variety of user input operations. For example, the keypad 16 may include alphanumeric keys 20 for allowing entry of alphanumeric information such as telephone numbers, phone lists, contact information, notes, etc. In addition, the keypad 16 may include special function keys 21 such as a “call send” key for initiating or answering a call, and a “call end” key for ending or “hanging up” a call. Special function keys 21 may also include activation dedicated function keys for activation of the camera. In addition, the special function keys 21 may also include a key for setting the camera in an image detection mode (as discussed below). Special function keys 21 may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. The call circuitry also may be responsible for transmitting text messages that are prepared by the user.

With additional reference to FIG. 2, additional components of the mobile telephone 10 will be described. For the sake of brevity, generally conventional features of the mobile telephone 10 will not be described in great detail herein. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform a camera function 22.

It will be apparent to a person having ordinary skill in the art of computer programming, and specifically in applications programming for mobile telephones or other electronic devices, how to program a mobile telephone 10 to operate and carry out the functions described herein. Accordingly, details as to the specific programming code have been left out for the sake of brevity. Also, while the camera function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1A, 1B and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system. The radio circuit 30 may be further configured to receive data and/or audiovisual content. For example, the receiver may be an IP datacast compatible receiver compatible with a hybrid network structure providing mobile communications and digital broadcast services, such as DVB-H mobile television and/or mobile radio. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation. Audio data may be passed from the control circuit 24 to the sound signal processing circuit 32 for playback to the user. The audio data may include, for example, audio data from an audio file stored by the memory 18 and retrieved by the control circuit 24. The sound processing circuit 32 may include any appropriate buffers, decoders, amplifiers and so forth.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be generated by the control circuit 24, retrieved from a video file that is stored in the memory 18, derived from an incoming video data stream received by the radio circuit 30 or obtained by any other suitable method. Prior to being fed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown), such as a headset (sometimes referred to as an earset) to audibly output sound signals output by the sound processing circuit 32 to the user. Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, automatically acquiring images at predetermined and/or user defined time intervals.

As indicated, the mobile telephone 10 may include a camera 48 for taking digital pictures and/or movies. Image and/or video files corresponding to the pictures and/or movies may be stored in the memory 18. In some embodiments, the mobile telephone 10 may include a flash 49 for assisting the camera 48 take photographs in certain illumination conditions.

The mobile telephone 10 also may include a position data receiver 50, such as a global positioning system (GPS) receiver, Galileo satellite system receiver or the like. The mobile telephone 10 also may include a local wireless interface 52, such as an infrared transceiver and/or an RF adaptor (e.g., a Bluetooth adapter), for establishing communication with an accessory, a hands-free adaptor (e.g., a headset that may audibly output sounds corresponding to audio data transferred from the mobile telephone 10 to the adapter), another mobile radio terminal, a computer or another device.

The mobile telephone 10 may be configured to transmit, receive and process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in the memory 18, executing applications to allow user interaction with data, displaying video and/or image content associated with the data, outputting audio sounds associated with the data and so forth.

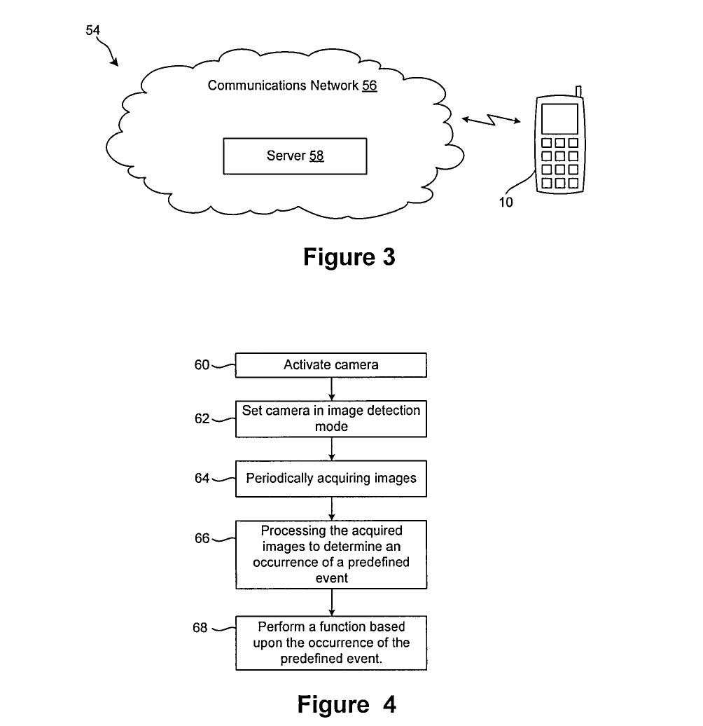

With additional reference to FIG. 3, the mobile telephone 10 may be configured to operate as part of a communications system 54. The system 54 may include a communications network 56 having a server 58 (or servers) for managing calls placed by and destined to the mobile telephone 10, transmitting data to the mobile telephone 10 and carrying out any other support functions. The server 58 communicates with the mobile telephone 10 via a transmission medium. The transmission medium may be any appropriate device or assembly, including, for example, a communications tower, another mobile telephone, a wireless access point, a satellite, etc. Portions of the network may include wireless transmission pathways. The network 56 may support the communications activity of multiple mobile telephones 10, although only one mobile telephone 10 is shown in the illustration of FIG. 3.

In one embodiment, the server 58 may operate in stand alone configuration relative to other servers of the network 56 or may be configured to carry out multiple communications network 58 functions. As will be appreciated, the server 58 may be configured as a typical computer system used to carry out server functions and may include a processor configured to execute software containing logical instructions that embody the functions of the server 58.

With additional reference to FIG. 4, illustrated is a flow chart of logical blocks that make up certain features the camera function 22. The flow chart may be thought of as depicting steps of a method. Although FIG. 4 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 60 by activating the camera 48. Activating the camera 48 may be invoked by user action, such as by pressing a particular key of the keypad 16. Activating the camera 48 may turn on the camera 48 or otherwise ready the camera 48 to take a photograph. In one embodiment, the display 14 may be used as an electronic viewfinder for the camera 48. As an electronic view finder, the display presents field of view associated with the camera. Through the electronic view finder, the user may focus the digital camera, playback stored images, videos, etc.

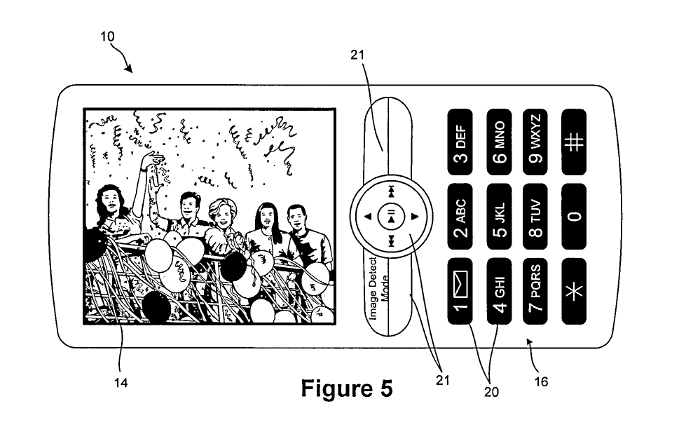

With additional reference to FIG. 5, shown is an exemplary mobile telephone 10 for which a camera 48 of the mobile telephone 10 has been turned on and the display 14 is used as a viewfinder. During use as a viewfinder, the display 14 may show images detected by the camera 48 to provide the user with an indication of the field of view of the camera 48 and what may be contained in a picture if a photograph were to be taken at that moment in time. The display 14 may be refreshed so that the image displayed on the display is a current representation of the field of view of the camera 48. In the illustrated example, the display 14 shows an image of a group of people who are in the field of view of the camera 48. The camera 48 is not illustrated in FIG. 5 as, in this embodiment, a lens of the camera 48 is located on an opposite side of the mobile telephone 10 from the display 14.

In the illustrated embodiment of FIG. 5, the mobile telephone 10 has function keys 21 and alphanumeric keys 20. At least one of the function keys 21 in this illustrated embodiment are specially marked for setting the camera in an image detection mode. As stated above, functions keys 21 may serve other functions when the mobile telephone 10 is used for various purposes. For example, the keys 21 may serve as a user interface for menu navigation, a user interface for camera activation and shutter operation, and so forth. Thus, the illustration of markings on the function keys 21 is for exemplary purposes and it will be understood that the function keys 21 may bear other markings. The alphanumeric keys 20 are those that one would typically find on a telephone keypad. As indicated, the keys 20 may be used to enter numbers or text, and may have additional functionality in certain operational modes of the mobile telephone 10. It will be appreciated that the number, function and arrangement of keys 20 and/or 21, as well as the text or symbols shown on the keys 20 and/or 21, may vary from mobile telephone 10 to mobile telephone 10.

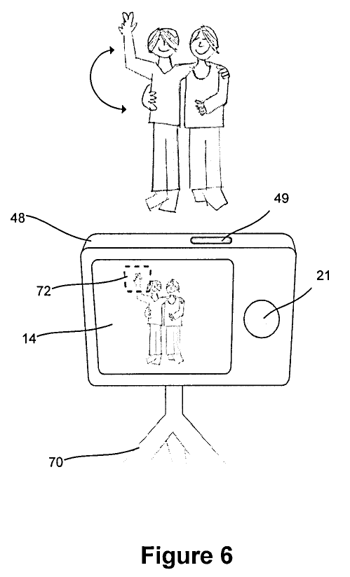

Proceeding to block 62, the camera 48 may be placed in an image detection mode by default operation and/or by user action. For example, the camera may be placed image detection mode by the user pressing the designated function key 21. As discussed in detail below, the image detection mode allows a user to remotely control the camera 48 by making a user action (e.g., a gesture) in the camera field (e.g., field of view) and the camera and/or mobile telephone performing a function based on the detected user action. Such an interface frees the user from taking a photograph behind the camera and provides that the user may be an active participant in the image to be photographed. In the image detection mode, the camera may be securely held by a tripod 70, as shown in FIG. 6.

At block 64, images are periodically acquired and stored in memory. The period of time between acquiring images may be any desirable period of time. The period may be selected from predefined periods of time and/or periods of time set by the user. Preferably, less than 10 seconds elapse between acquiring two images. If too much time elapses, it may be difficult to detect a predefined user action due to the subjects in the field of view of the camera moving between acquired images.

The images may be temporarily stored in memory until a predefined event occurs. At step 66, the images are processed to determine an occurrence of a predefined event. The images may be processed in any manner to determine whether a predefined event has occurred. For example, two or images may be compared to each other to determine if a predetermined event has occurred. In another example, each image may be searched for the existence of a predetermined event. The predefined events may be any detectable user action. Suitable user actions include, for example, user gestures, hand waving, raising and/or lowering an arm, arm flapping, making a sign with the user's hand (e.g., the “peace sign”, as shown in FIG. 6), the user sticking his or her tongue out, etc.

To assist the user in determining that a predefined user action has been detected by the camera, an audible (e.g., a beep) or viewable (e.g., flash or a blinking light emitting diode) signal may be directed to the user. In this way, the user is not kept guessing as to whether the user action has been detected.

According to aspects of the present invention, it is possible for the user to enter new user actions into a library of predefined user actions. There are a variety of methods for training the system to recognize a new user action. All such methods fall with in the scope of the present invention. One process for training is through training the system to recognize the new gesture. The training feature can also be used to show the system how a particular person does one of the already known user actions, such as an arm flap. For example, a particular person may not raise her arms as high as someone with longer arms. By showing the system how a particular person performs a user action, the system will be more likely to recognize that gesture done by that person and recognize it sooner and with a greater confidence level. This is a useful procedure for frequent users or for users who pattern one user action frequently.

Generally, in order to learn a predefined event, a learning or training procedure is performed. Any suitable method for training the system to recognize a user action may be used in accordance with the present invention. For example, in one embodiment, samples of the new user action are taken. The images are associated with a particular user action and stored. Another method includes providing samples of the new user action performing the user action in the field of the camera a certain number of times. This, naturally, requires some user intervention. In a preferred embodiment, the user or users perform the new user action about 10 times. The number of users and the number of samples have a direct bearing on the accuracy of the model representing the user action and the accuracy of the statistics of each key point. The more representative samples provided to the system, the more robust the recognition process will be. In one embodiment, a number of key points in the user action are identified and entered. For example, a user action that comprises a “peace” sign, the area of interest is around the actor's hand. The key points are then identified and associated with a particular function to be performed when the user action is determined.

At step 68, once the predefined user action is detected and/or determined, a function is performed based on the occurrence of the predefined user action. The function performed may be any function capable of being performed by the mobile telephone 10 and/or camera 48. For example, the function may be that of a self-timer that causes the camera 48 to take a picture immediately after the predefined user action has been detected or after a delay (e.g., one to three seconds) to allow the user to be photographed in a normal position, instead of always being photographed while making the predefined user action. Other suitable functions include: acquiring a video of the view field after the occurrence of the predefined event, acquiring a series of images of the in the form of individual images at a predetermined time interval after the occurrence of the predefined event, etc.

Referring to FIG. 6, an exemplary embodiment is illustrated. In FIG. 6, the camera 48 is secured to a tripod 70. As stated above, the camera 48 may also be any electronic equipment equipped with camera and/or video functionality. The camera 48 is activated and set to an image detection mode. The display 14 performs the function of a viewfinder, as discussed above. The image in the viewfinder is of two persons with their arms around each other. As stated above, the camera 48 periodically acquires images in the viewfinder. The images are processed to determine an occurrence of a predefined user event (also referred to herein as a user action). When the subjects are ready to be photographed, a user may perform the predefined event. As shown in FIG. 6, the area of interest 72 has been detected as

The person with her arm raised is performing a predefined user action, which is stored in memory. As shown in FIG. 6, the area of interest 72 has been detected by the processor as a predefined user event. In this case, the person is making a “peace” sign with her right hand. The predefined user action is successfully detected by processing the acquired images and a function is performed based upon the occurrence of the predefined event. For example, in this particular instance, a photograph of the two individuals is taken and stored in memory. Other functions may be associated with detection of the “peace” sign. Other such functions may include, for example, acquiring a plurality of images at predetermined times, acquiring a video of the scene, etc. Once the predefined user action has been detected, an optional audible and/or visual indication may be made to the users that the user action has been detected.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method of using a camera, the method comprising:
providing a camera including a display for presenting one or more images in a viewfinder to an associated user, a memory for storing the one or more images, and a processor for processing information associated with the image and displaying the one or more images on the display;
activating the camera;
setting the camera in an image detection mode;
periodically acquiring images in the viewfinder and storing a least one of the acquired images in the memory;
processing the periodically acquired images to determine an occurrence of a predefined event; and
performing a function based upon the occurrence of the predefined event.

2. The method of claim 1, wherein the camera is housed in a mobile telephone.

3. The method of claim 1, wherein the camera is configured to be set to the image detection mode by an associated user depressing a key.

4. The method of claim 1, wherein the periodically acquired images are acquired in a period of less than ten seconds from each other.

5. The method of claim 1 further including learning the one or more predefined events and storing the one or more predefined events in memory.

6. The method of claim 5, wherein the step of learning the one or more predefined events includes determining differences in the periodically acquired images.

7. The method of claim 6, wherein the step of processing the periodically acquired images includes searching for one or more predefined events in at least one image.

8. The method of claim 5, wherein the one or more predefined events includes a user gesture from an associated user located in the image view field.

9. The method of claim 1, wherein the function includes acquiring an image after the occurrence of the predefined event.

10. The method of claim 9, wherein a predefined time expires prior to performing the function after the occurrence of the predefined event.

11. The method of claim 1, wherein the function includes acquiring a video of the view field after the occurrence of the predefined event.

12. The method of claim 1, wherein the function includes acquiring a series of images in the form of individual images at a predetermined time interval after the occurrence of the predefined event.

13. A mobile radio terminal, comprising:
a radio circuit for establishing communication with a communications network;
a camera for taking digital photographs;
a display; and
a control circuit configured to execute image detection logic to:
periodically acquiring images and storing a least one of the sampled view fields in the memory;
processing the periodically acquired images to determine an occurrence of a predefined event; and
performing a function based upon the occurrence of the predefined event.

14. The mobile radio terminal of claim 13, wherein the control circuit is configured to execute the image detection mode by an associated user depressing a key.

15. The mobile radio terminal of claim 13, wherein the periodically acquired image occurs in a period of less than ten seconds.

16. The mobile radio terminal of claim 13 further including a memory for storing one or more predefined events, wherein the memory is coupled to the control circuit.

17. The mobile radio of claim 13, wherein the step of processing the periodically acquired image includes searching for one or more predefined events in the image stored in memory.

18. The mobile radio of claim 13, wherein the one or more predefined events includes a user gesture from an associated user located in the image.

19. The mobile radio of claim 13, wherein the function includes acquiring an image after the occurrence of the predefined event.

20. The mobile radio of claim 19, wherein a predefined time expires prior to performing the function after the occurrence of the predefined event.

21. An electronic equipment, comprising:
a camera for taking digital photographs;
a display; and
a control circuit configured to execute image detection logic to:
periodically acquiring images and storing a least one of the sampled view fields in the memory;
processing the periodically acquired images to determine an occurrence of a predefined event; and
performing a function based upon the occurrence of the predefined event.
